(19) United States
(12) Patent Application Publication
(10) Pub. No.: US 2026/0233334 A1
(43) Pub. Date: Aug. 13, 2026

(54) LASER PROCESSING APPARATUS AND ELECTRONIC DEVICE

(71) Applicant: Samsung Display Co., Ltd., Yongin-Si (KR)

(72) Inventors: Kang Hyuk LEE, Yongin-si (KR); Hak Min KIM, Yongin-si (KR)

(21) Appl. No.: 19/314,454

(22) Filed: Aug. 29, 2025

(30) Foreign Application Priority Data
Feb. 10, 2025 (KR) 10-2025-0016807

(51) Int. Cl. B23K 26/16; B23K 26/36; B23K 26/70

(52) U.S. Cl. CPC B23K 26/16; B23K 26/36; B23K 26/702

(57) ABSTRACT

A laser processing apparatus includes a laser unit irradicating a laser beam along a processing line of a target substrate to process the target substrate, a table including a panel table supporting the target substrate and a fume blocking wall surrounding the panel table, a cover including an opening overlapping the panel table and fume discharge slits overlapping a space between the panel table and the fume blocking wall, and a suction cup suctioning fume generated during processing of the target substrate and positioned between the cover and the laser unit. The suction cup includes a first suction hole at least partially overlapping an edge of the panel table, and a second suction hole overlapping at least one of the fume discharge slits.

### CROSS-REFERENCE TO RELATED APPLICATION

This application claims priority to and the benefit of Korean Patent Application No. 10-2025-0016807 filed in the Korean Intellectual Property Office on Feb. 10, 2025, the entire contents of which are incorporated herein by reference.

### BACKGROUND

### 1. Field

The present disclosure relates to a laser processing apparatus and an electronic device.

### 2. Description of the Related Art

Recently, as interest in information display has increased, research and development on a display device and an electronic device including the same have been continuously carried out.

### SUMMARY OF THE INVENTION

An embodiment of the present disclosure provides a laser processing apparatus capable of effectively removing fume generated during a laser processing.

The feature of the present disclosure is not limited to the feature mentioned above, and other technical features that are not mentioned may be clearly understood by those skilled in the art from the following description.

According to an embodiment of the present disclosure, a laser processing apparatus includes a laser unit irradicating a laser beam along a processing line of a target substrate to process the target substrate, a table including a panel table supporting the target substrate and a fume blocking wall surrounding the panel table, a cover including an opening overlapping the panel table and fume discharge slits overlapping a space between the panel table and the fume blocking wall, and a suction cup suctioning fume generated during processing of the target substrate and disposed between the cover and the laser unit. The suction cup includes a first suction hole at least partially overlapping an edge of the panel table, and a second suction hole overlapping at least one of the fume discharge slits.

The table may further include air inlet holes surrounding the edge of the panel table.

The air inlet holes may be located between the panel table and the fume blocking wall.

Outside air may be introduced into a space between the panel table and the fume blocking wall through the air inlet holes.

Fume generated from a lower side of the target substrate may move to the at least one of the fume discharge slits by the outside air.

The fume generated from the lower side of the target substrate may move to the second suction hole through the fume discharge slits.

The table may further include dummy blocks supporting the cover.

The dummy blocks may surround the edge of the panel table.

The air inlet holes may be located between the panel table and the dummy blocks.

The fume blocking wall may surround the dummy blocks.

The laser beam may pass between the panel table and the dummy blocks.

The first suction hole may suction and remove fume generated from an upper side of the target substrate.

The laser beam may pass through the first suction hole.

The second suction hole may suction and remove fume generated from a lower side of the target substrate.

The fume blocking wall may at least partially surround an edge of the fume discharge slits.

The suction cup may further include an exhaust port which discharges suctioned fume to outside.

The second suction hole may include a first hole and a second hole spaced apart from each other.

According to an embodiment of the present disclosure, an electronic device includes a processor, and a display panel manufactured using a laser processing apparatus. The laser processing apparatus includes a laser unit irradicating a laser beam along a processing line of a target substrate to process the target substrate, a table including a panel table supporting the target substrate and a fume blocking wall surrounding the panel table, a cover including an opening overlapping the panel table and fume discharge slits overlapping a space between the panel table and the fume blocking wall, and a suction cup suctioning fume generated during processing of the target substrate and disposed between the cover and the laser unit. The suction cup includes a first suction hole at least partially overlapping an edge of the panel table, and a second suction hole overlapping at least one of the fume discharge slits.

The table may further include air inlet holes surrounding the edge of the panel table.

The display panel may be cut by the laser processing apparatus.

Specific details of the embodiments are included in the detailed description and drawings.

According to the above-described embodiment, it is possible to effectively remove fume generated from a lower side of the target substrate using a fume blocking wall and a fume discharge slit formed in a work table.

Effects and features according to embodiments are not limited by what is illustrated above, and more diverse effects and features are included in the present specification.

### BRIEF DESCRIPTION OF THE DRAWINGS

FIG. 1 is a perspective view of a laser processing apparatus according to an embodiment.

FIG. 2 is a perspective view of a work table according to an embodiment.

FIG. 3 is a plan view of a table according to an embodiment.

FIG. 4 is an enlarged perspective view of a part of a table according to an embodiment.

FIG. 5 is an enlarged perspective view of a part of a work table according to an embodiment.

FIG. 6 is a plan view of a suction cup according to an embodiment.

FIGS. 7 and 8 are plan views illustrating parts of a processing procedure of a laser processing apparatus according to an embodiment.

FIGS. 9 and 10 are exemplary views illustrating a fume suction process of a laser processing apparatus according to an embodiment.

FIG. 11 is a plan view of a display panel according to an embodiment.

FIG. 12 is a block diagram of an electronic device according to an embodiment.

FIG. 13 is a schematic diagram of an electronic device according to various embodiments.

### DETAILED DESCRIPTION OF THE EMBODIMENTS

Hereinafter, an embodiment according to the present disclosure may be described in detail with reference to the accompanying drawings. It should be noted that in the following description, only the parts necessary to understand the operation of the inventive concept of the present disclosure are described, and descriptions of other parts will be omitted so as not to obscure the gist of the present disclosure. The present disclosure is not limited to the embodiments described herein, and may be implemented in various forms. However, the embodiments described herein are provided to explain the technical feature of the present disclosure in detail to a person skilled in the art to which the present disclosure pertains.

Throughout the specification, when a part is “connected” to another part, this may include not only a case where the part is “directly connected” but also a case where it is “indirectly connected” with another element interposed therebetween. The terminology used herein is for the purpose of describing particular embodiments and is not intended to limit the invention. Throughout the specification, when it is said that a part may “include” a component, this may mean that other components may be further included, rather than excluding other components, unless otherwise specified. “At least one of X, Y, and Z”, and “at least one selected from the group consisting of X, Y and Z”, can be interpreted as one X, one Y, one Z, or any combination of two or more of X, Y or Z (e.g., XYZ, XY, YZ, ZZ). Here, “and/or” may include all combinations of one or more of the corresponding configurations.

Here, terms such as first, second, and the like may be used to describe various components, but these components are not limited to these terms. These terms may be used to distinguish one component from another. Accordingly, a first component may refer to a second component without departing from what is disclosed herein.

Spatially relative terms such as “below”, “above”, and the like may be used for purposes of description, thereby describing a relationship of one element or feature to another element(s) or feature(s), as shown in the drawing. Spatially relative terms are intended to include different directions in use, operation, and/or manufacture, in addition to the directions depicted in the figures. For example, if the device shown in the drawing is flipped over, elements depicted as being “below” other elements or features may be positioned in a direction “above” the other elements or features. Thus, in an embodiment, the term “below” may represent both directions above and below. In addition, the device may be directed in another direction (e.g., rotated 90 degrees or in another direction), and thus, the spatially relative terms used herein may be interpreted accordingly.

Various embodiments may be described with reference to the drawing. Accordingly, it will be appreciated that the shapes may vary depending on, for example, tolerances and/or manufacturing techniques. Accordingly, the embodiments disclosed herein may not be construed as limited to the particular shapes shown in the drawings, but may be construed as including, for example, changes in shapes that occur as a result of fabrication. As such, the shapes shown in the drawings may not show actual shapes of regions of the apparatus, and the present embodiments are not limited thereto.

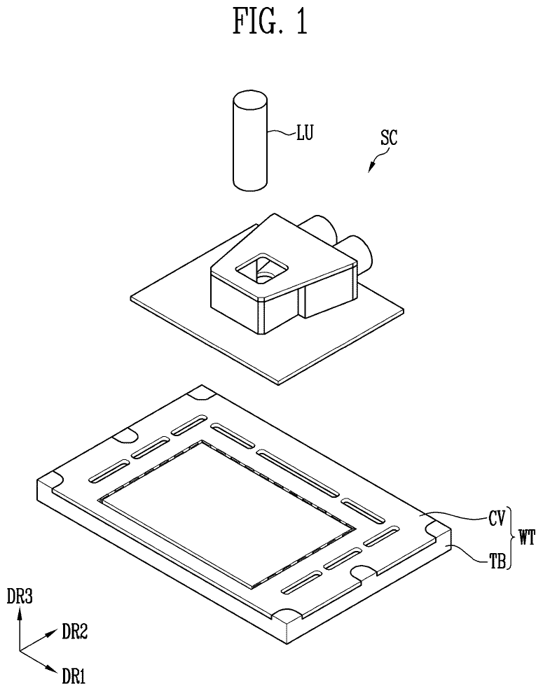

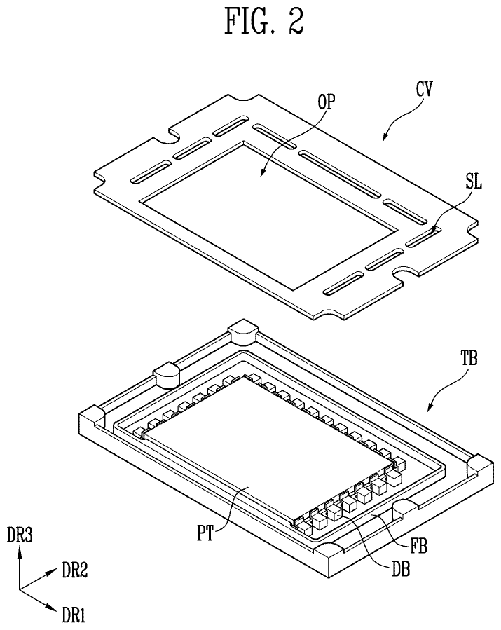

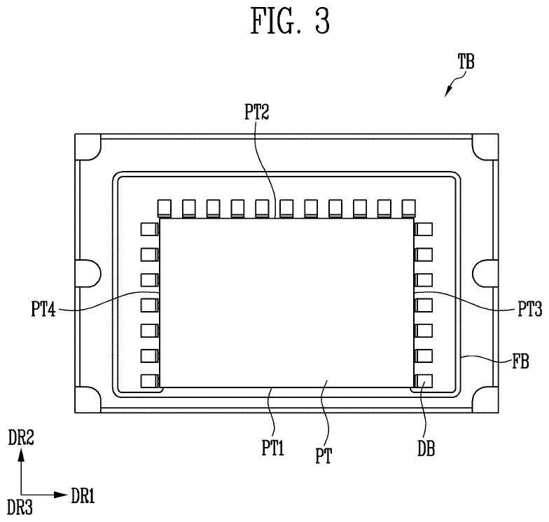

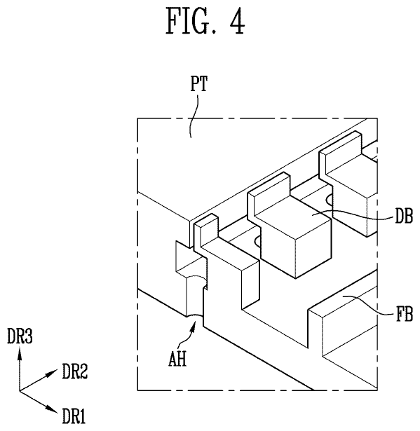

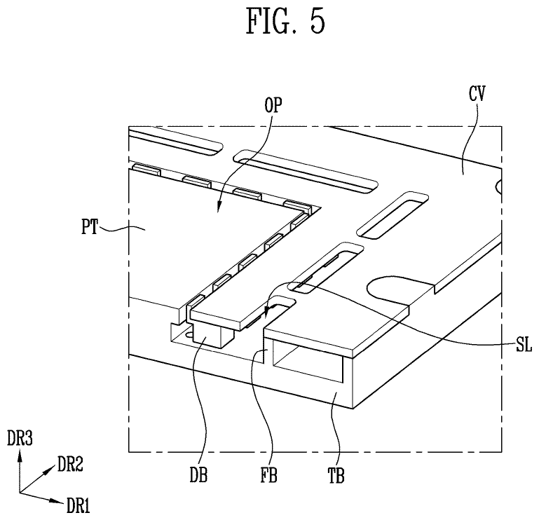

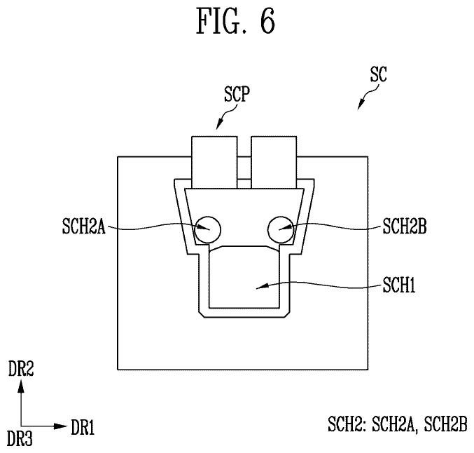

FIG. 1 is a perspective view of a laser processing apparatus according to an embodiment. FIG. 2 is a perspective view of a work table according to an embodiment. FIG. 3 is a plan view of a table according to an embodiment. FIG. 4 is an enlarged perspective view of a part of a table according to an embodiment. FIG. 5 is an enlarged perspective view of a part of a work table according to an embodiment. FIG. 6 is a plan view of a suction cup according to an embodiment.

Referring to FIGS. 1 to 6, a laser processing apparatus according to an embodiment may include a laser unit LU, a work table WT, and a suction cup SC.

The laser unit LU may irradiate a laser beam along a processing line of a target substrate to process and, for example, cut the target substrate. The target substrate processed or cut by the laser processing apparatus may be a display panel, a display device, an electronic device, and/or a substrate. According to an embodiment, the laser unit LU may further include a homogenizer for homogenizing a shape of the laser beam and/or a condenser lens for condensing the laser beam. However, the laser unit LU of the present disclosure is not necessarily limited thereto.

The work table WT may include a table TB and a cover CV. The table TB may support the target substrate. The cover CV may be disposed on the table TB. In an embodiment, the table TB and the cover CV of the work table WT may be assembled or combined with each as shown in FIG. 1. For example, the table TB and the cover CV of the work table WT may be separated from each other as shown in FIG. 2.

In an embodiment, the work table WT may move or rotate in a first direction DR1 and a second direction DR2. However, the present disclosure is not necessarily limited thereto, and the work table WT may be fixed.

The table TB may include a panel table PT, dummy blocks DB, a fume blocking wall (or fume barrier) FB, and air inlet holes AH.

The panel table PT may support the target substrate. The target substrate may be seated on the panel table PT. In an embodiment, the panel table PT may be located in a center of the table TB on a plane, but the position of the panel table PT with respect to the table TB is not necessarily limited thereto. The panel table PT may include first to fourth sides PT1 to PT4. The first side S1 and the second side S2 may extend along the first direction DR1 and may be spaced apart from each other in the second direction DR2. The third side S3 and the fourth side S4 may extend along the second direction DR2 and may be spaced apart from each other in the first direction DR1. The third side S3 may be located between the first side S1 and the second side S2. The fourth side S4 may be located between the first side S1 and the second side S2.

The dummy blocks DB may serve to support the cover CV. The dummy blocks DB may at least partially surround an edge of the panel table PT in a plan view. For example, the dummy blocks DB may surround the second to fourth sides PT2 to PT4 of the panel table PT in a plan view. However, the present disclosure is not necessarily limited thereto, and the dummy blocks DB may entirely surround the first to fourth sides PT1 to PT4 of the panel table PT in a plan view.

A laser beam may pass through a space between the edge of the panel table PT and the dummy blocks DB. Accordingly, fume generated during the processing of the target substrate may be applied to the space between the edge of the panel table PT and the dummy blocks DB (or the fume blocking wall FB). If the fume spreads around a laser processing apparatus, it may not only be harmful to workers but also affect processing quality by contaminating the target substrate or the laser processing apparatus.

The fume blocking wall FB may serve to prevent fume generated during the processing of the target substrate from spreading around the laser processing apparatus and effectively maintain suction force when removing the fume. The fume blocking wall FB may at least partially surround an edge of the panel table PT in a plan view. For example, the fume blocking wall FB may surround at least portions of the first to fourth sides PT1 to PT4 of the panel table PT in a plan view. The fume blocking wall FB may at least partially surround the dummy blocks DB in a plan view.

The air inlet holes AH may serve as a passage through which outside air may be introduced into the work table WT. The outside air may be introduced into the space between the panel table PT and the fume blocking wall FB through the air inlet holes AH.

The air inlet holes AH may penetrate the table TB in a third direction DR3. The air inlet holes AH may at least partially surround an edge of the panel table PT in a plan view. The air inlet holes AH may be located between the edge of the panel table PT and the dummy blocks DB (or the fume blocking wall FB) in a plan view.

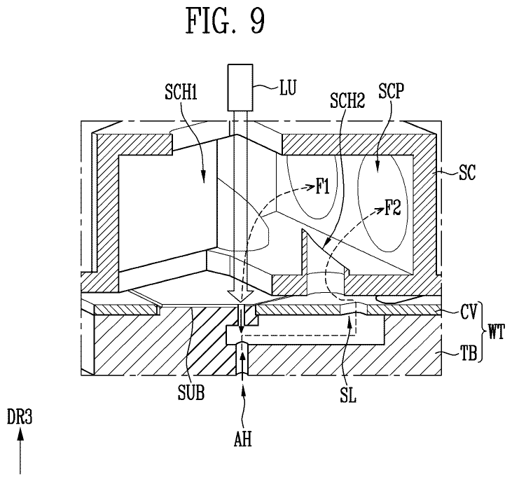

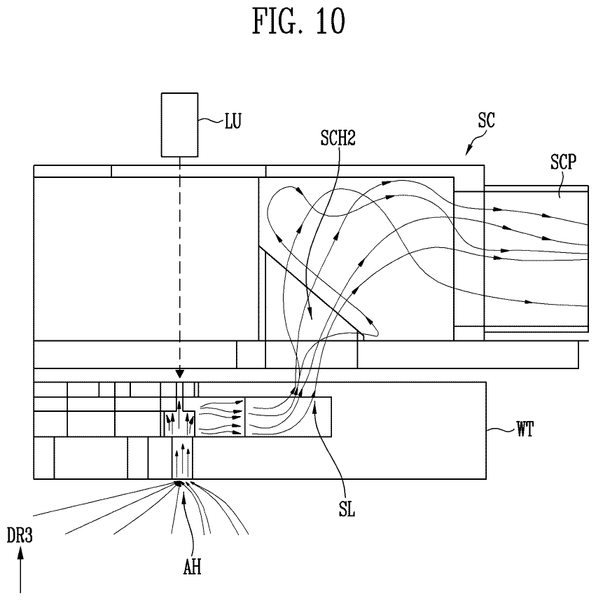

The fume generated from a lower side of the target substrate may be moved to fume discharge slits SL of the cover CV by outside air. The fume generated from the lower side of the target substrate may be discharged through the fume discharge slits SL and suctioned away by the suction cup SC. A detailed description thereof will be described later with reference to FIGS. 9 and 10.

The cover CV may be coupled with the table TB and serve to induce airflow within the work table WT. The cover CV may include an opening OP that overlaps the panel table PT of the table TB. The opening OP of the cover CV may expose the panel table PT of the table TB. The opening OP of the cover CV may have the same planar shape as the panel table PT of the table TB, but the shape of the opening OP of the cover CV is not necessarily limited thereto.

The cover CV may include fume discharge slits SL. The fume discharge slits SL may overlap a space between the panel table PT and the fume blocking wall FB. The fume blocking wall FB may at least partially surround an edge of the fume discharge slits SL.

The fume discharge slits SL may overlap the space between the dummy blocks DB and the fume blocking wall FB. The fume generated from the lower side of the target substrate may be discharged to the outside of the work table WT through the fume discharge slits SL and suctioned away by the suction cup SC. A detailed description thereof will be described later with reference to FIGS. 9 and 10.

The suction cup SC may be positioned between the laser unit LU and the work table WT (or the cover CV). The suction cup SC may suction the fume generated when the target substrate is processed.

The suction cup SC may include a first suction hole SCH1, second suction holes SCH2, and exhaust ports SCP. The first suction hole SCH1 may suction fume generated from an upper side of the target substrate. The first suction hole SCH1 may provide a passage through which the laser beam passes. The first suction hole SCH1 may prevent the laser beam from being covered by the fume. To this end, the first suction hole SCH1 may at least partially overlap a processing line of the target substrate. The first suction hole SCH1 may overlap an edge of the panel table PT.

The second suction holes SCH2 may suction the fume generated from the lower side of the target substrate. For example, the fume generated under the target substrate may pass through the fume discharge slits SL of the cover CV and move to the second suction holes SCH2. To this end, at least one of the second suction holes SCH2 may overlap at least one of the fume discharge slits SL of the cover CV.

The second suction holes SCH2 may include a first hole SCH2A and a second hole SCH2B spaced apart from each other. The first hole SCH2A and/or the second hole SCH2B may overlap at least one of the fume discharge slits SL according to a movement path of the work table WT. FIG. 6 illustrates an embodiment in which the second suction holes SCH2 include two holes SCH2A and SCH2B, but the number of the second suction holes SCH2 is not necessarily limited thereto.

The exhaust ports SCP may discharge the suctioned fume through suction holes SCH1 and SCH2 to outside. FIG. 6 illustrates an embodiment in which the suction cup SC includes two exhaust ports SCP, but the number of the suction cup SC is not necessarily limited thereto. The exhaust ports SCP may be connected to a dust collection unit (not shown) or the like to provide a vacuum pressure for transferring the fume to the outside of the laser processing apparatus.

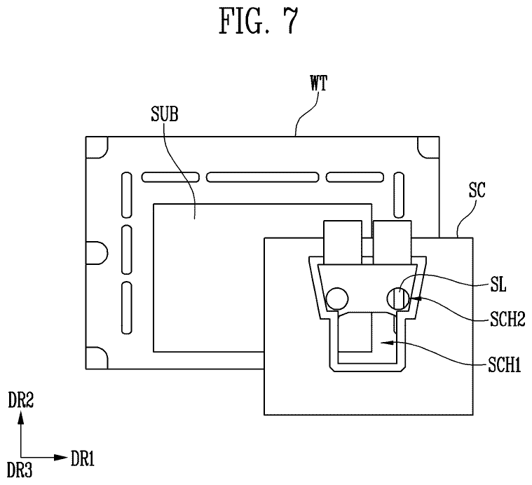

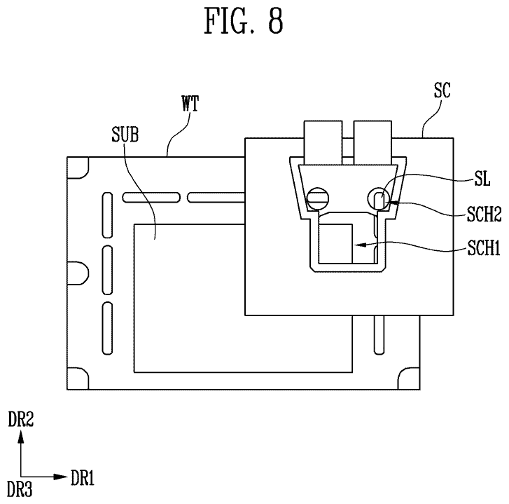

FIGS. 7 and 8 are plan views illustrating parts of a processing procedure of a laser processing apparatus according to an embodiment.

Referring to FIGS. 7 and 8, a target substrate, for example, a substrate SUB, may be seated on the work table WT of the laser processing apparatus. Positions of the laser unit LU and the suction cup SC may be fixed. In this case, the work table WT may move in the first direction DR1 and the second direction DR2 to carry out the laser processing. A movement path of the work table WT may be set so that a processing line of the substrate SUB aligns with a position where the laser beam is irradiated.

Even when the work table WT is moved, the first suction hole SCH1 of the suction cup SC may always overlaps the processing line of the substrate SUB and may continuously remove the fume generated from the upper side of the substrate SUB.

Even when the work table WT is moved, the second suction hole SCH2 of the suction cup SC may always overlaps the fume discharge slit SL of the cover CV and can continuously remove the fume generated from the lower side of the substrate SUB.

However, it is not necessarily limited thereto, and according to an embodiment, the work table WT may be fixed, and the laser unit LU and the suction cup SC may move along the processing line of the substrate SUB. However, even if the work table WT is fixed and the laser unit LU and the suction cup SC move along the processing line of the substrate SUB, the first suction hole SCH1 of the suction cup SC may always overlaps with the processing line of substrate SUB, and the fume generated from the upper side of the substrate SUB may be removed. In addition, the second suction hole SCH2 of the suction cup SC may always overlaps with the fume discharge slit SL of the cover CV and may continuously remove the fume generated from the lower side of the substrate SUB.

FIGS. 9 and 10 are exemplary views illustrating a fume suction process of a laser processing apparatus according to an embodiment.

Referring to FIGS. 9 and 10, the laser beam irradiated from the laser unit LU may pass through the first suction hole SCH1 to process or cut the substrate SUB that is the target substrate. In the process of processing or cutting the substrate SUB, fume F1 may be generated or occur from an upper side of the substrate SUB. The fume F1 generated on the substrate SUB may be suctioned by the first suction hole SCH1 of the suction cup SC on the work table WT. The fume F1 generated from the upper side of the substrate SUB may be suctioned by the first suction hole SCH1 and removed through the exhaust ports SCP.

In processing or cutting the substrate SUB, fume F2 may be generated or occur from a lower side of the substrate SUB. Under the substrate SUB, the fume F2 may be moved to the fume discharge slits SL of the cover CV by outside air introduced through the air inlet hole AH. The fume F2 generated from the lower side of the substrate SUB may move through the fume discharge slits SL to the top of the work table WT. Accordingly, the fume F2 generated under the substrate SUB may be suctioned by the second suction hole SCH2 on the work table WT. The fume F2 generated from the lower side of the substrate SUB may be suctioned by the second suction hole SCH2 and removed through the exhaust ports SCP.

According to the above-described laser processing apparatus, it is possible to simultaneously remove not only the fume F1 generated from the upper side of the substrate SUB, which is the target substrate, but also the fume F2 generated from the lower side of the substrate SUB by using one suction cup SC, so that a size of the laser processing apparatus can be minimized.

Hereinafter, a display panel DP processed or cut by the above-described laser processing apparatus and an electronic device including the same will be described.

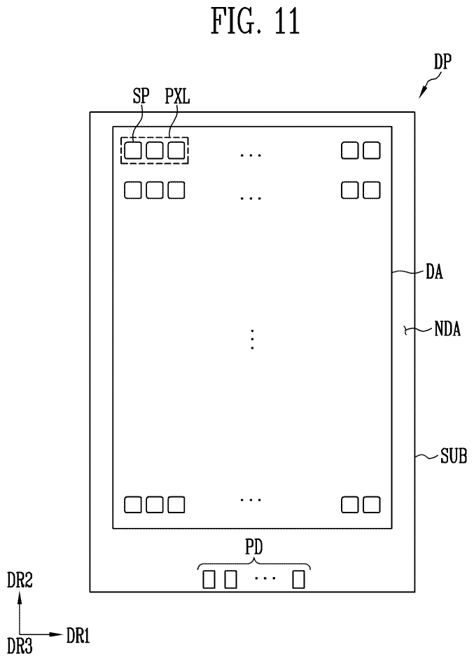

FIG. 11 is a plan view of a display panel according to an embodiment.

Referring to FIG. 11, the display panel DP may include a display area DA and a non-display area NDA. The display panel DP may display an image through the display area DA. The non-display area NDA may be located around the display area DA.

The display panel DP may include a substrate SUB, sub-pixels SP, and pads PD.

The sub-pixels SP may be located in the display area DA on the substrate SUB. The sub-pixels SP may be arranged in a matrix form along a first direction DR1 and a second direction DR2 intersecting the first direction DR1. However, embodiments are not limited thereto. For example, the sub-pixels SP may be arranged in a zigzag shape along the first direction DR1 and the second direction DR2. For example, the sub-pixels SP may be arranged in a PENTILE™ form. The first direction DR1 may be a row direction, and the second direction DR2 may be a column direction. Two or more sub-pixels of the sub-pixels SP may constitute one pixel PXL.

The pads PD may be located in the non-display area NDA on the substrate SUB. The pads PD may be electrically connected to the sub-pixels SP through wirings.

The pads PD may interface the display panel DP to other components of the display device. In an embodiment, voltages and signals required for operation of the components included in the display panel DP may be provided from a driver integrated circuit through the pads PD.

In an embodiment, a circuit board may be electrically connected to the pads PD using a conductive adhesive member such as an anisotropic conductive film. In this case, the circuit board may be a flexible circuit board or a flexible film having a flexible material. The driver integrated circuit may be mounted on the circuit board and electrically connected to the pads PD.

In an embodiment, the display area DA may have various shapes. The display area DA may have the shape of a closed loop including straight and/or curved sides. For example, the display area DA may have shapes such as a polygon, a circle, a semicircle, an ellipse, or the like.

In an embodiment, the display panel DP may have a flat display surface. However, the present disclosure is not limited thereto. For example, the display panel DP may have an at least partially rounded display surface. In an embodiment, the display panel DP may be bendable, foldable, or rollable. In such cases, the display panel DP and/or the substrate SUB may include materials having a flexible property.

The display panel DP may include a substrate, display elements disposed on the substrate, at least one conductive line disposed on the substrate and electrically connected to the display elements, and/or a thin film encapsulation layer.

The display elements may be disposed on the substrate to form a plurality of pixels. For example, the display elements may be arranged in a matrix form on the substrate to form the pixels of the display panel DP. For example, the display elements may include an organic light emitting diode (OLED), but embodiments of the present disclosure are not necessarily limited thereto.

The conductive line may include at least one gate signal line or at least one data signal line. The conductive line may include gate signal lines and data signal lines. In this case, the gate signal lines and the data signal lines may be arranged in a matrix form, and the display elements may be disposed in a position where the lines intersect to be electrically connected to the lines.

The thin film encapsulation layer may cover the substrate, the display elements, and/or the conductive line to prevent oxygen and moisture from penetrated into the display panel DP from the outside. The thin film encapsulation layer may be formed by alternately stacking one or more organic film layers and one or more inorganic film layers. In this case, the uppermost layer of the thin film encapsulation layer may be formed of an inorganic layer to prevent moisture permeation, but the embodiment of the present disclosure is not necessarily limited thereto.

The display panel DP according to an embodiment may be applied to various electronic devices. The electronic device according to an embodiment includes the display panel DP described above, and may further include a module or device having an additional function other than the display panel DP.

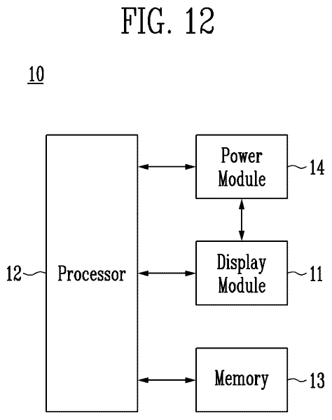

FIG. 12 is a block diagram of an electronic device according to an embodiment.

Referring to FIG. 12, an electronic device 10 according to an embodiment may include a display module 11, a processor 12, a memory 13, and a power module 14.

The processor 12 may include at least one of a central processing unit (CPU), an application processor (AP), a graphics processing unit (GPU), a communication processor (CP), an image signal processor (ISP), and a controller.

The memory 13 may store data information necessary for the operation of the processor 12 or the display module 11. When the processor 12 executes an application stored in the memory 13, an image data signal and/or an input control signal are transmitted to the display module 11, and the display module 11 may process the received signal and output image information through a display screen using a plurality of pixels.

The power module 14 may include a power supply module such as a power adapter, a battery device, or the like, and a power conversion module that converts power supplied by the power supply module to generate power necessary for operation of the electronic device 10.

At least one of the above-described components of the electronic device 10 may be included in the display device according to the above-described embodiments. In addition, some parts of individual modules functionally included in one module may be included in the display device, and other parts may be provided separately from the display device. For example, the display device may include the display module 11, and the processor 12, the memory 13, and the power module 14 may be provided in the form of other devices in the electronic device 10 other than the display device.

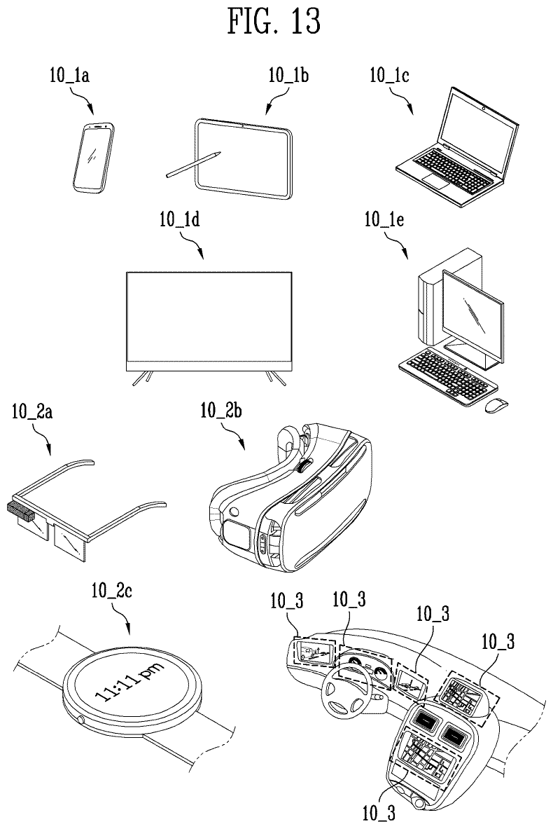

FIG. 13 is a schematic diagram of an electronic device according to various embodiments.

Referring to FIG. 13, various electronic devices to which a display device according to embodiments is applied may include not only an electronic device for displaying an image such as a smartphone 10_1a, a tablet PC 10_1b, a laptop 10_1c, a TV 10_1d, and a desk monitor 10_1e, but also a wearable electronic device including a display module such as smart glasses 10_2a, a head mounted display 10_2b, and a smart watch 10_2c. The electronic device to which the display device according to embodiments is applied may further include an automotive electronic device 10_3 including a display module, such as a CID (Center Information Display) disposed on an instrument panel, a center fascia, and a dashboard of a vehicle, a room mirror display, and the like.

Although certain embodiments have been described herein, other embodiments and variations may be derived from the above description. Accordingly, it should be noted that the above-described embodiments are for the purpose of description and are not intended to limit the meaning and the scope of the disclosure described in claims. In addition, those skilled in the art may understand that various modifications are possible within the scope of the technical spirit of the disclosure as set forth in the following claims.

What is claimed is:

1. A laser processing apparatus comprising:
a laser unit irradiating a laser beam along a processing line of a target substrate to process the target substrate;
a table including a panel table supporting the target substrate and a fume blocking wall surrounding the panel table;
a cover including an opening overlapping the panel table and fume discharge slits overlapping a space between the panel table and the fume blocking wall; and
a suction cup suctioning fume generated during processing of the target substrate and positioned between the cover and the laser unit,
wherein the suction cup includes a first suction hole at least partially overlapping an edge of the panel table, and a second suction hole overlapping at least one of the fume discharge slits.

2. The laser processing apparatus of claim 1, wherein the table further includes air inlet holes surrounding the edge of the panel table.

3. The laser processing apparatus of claim 2, wherein the air inlet holes are located between the panel table and the fume blocking wall.

4. The laser processing apparatus of claim 2, wherein outside air is introduced into a space between the panel table and the fume blocking wall through the air inlet holes.

5. The laser processing apparatus of claim 4, wherein fume generated from a lower side of the target substrate moves to the at least one of the fume discharge slits by the outside air.

6. The laser processing apparatus of claim 5, wherein the fume generated from the lower side of the target substrate moves to the second suction hole through the fume discharge slits.

7. The laser processing apparatus of claim 2, wherein the table further includes dummy blocks supporting the cover.

8. The laser processing apparatus of claim 7, wherein the dummy blocks surround the edge of the panel table.

9. The laser processing apparatus of claim 7, wherein the air inlet holes are located between the panel table and the dummy blocks.

10. The laser processing apparatus of claim 7, wherein the fume blocking wall surrounds the dummy blocks.

11. The laser processing apparatus of claim 7, wherein the laser beam passes between the panel table and the dummy blocks.

12. The laser processing apparatus of claim 11, wherein the first suction hole suctions and removes fume generated from an upper side of the target substrate.

13. The laser processing apparatus of claim 11, wherein the laser beam passes through the first suction hole.

14. The laser processing apparatus of claim 11, the second suction hole suctions and removes fume generated from a lower surface of the target substrate.

15. The laser processing apparatus of claim 11, wherein the fume blocking wall at least partially surrounds an edge of the fume discharge slits.

16. The laser processing apparatus of claim 11, wherein the suction cup further includes an exhaust port which discharges suctioned fume to outside.

17. The laser processing apparatus of claim 11, wherein the second suction hole includes a first hole and a second hole spaced apart from each other.

18. An electronic device comprising:
a processor; and
a display panel manufactured using a laser processing apparatus,
wherein the laser processing apparatus including:
a laser unit irradiating a laser beam along a processing line of a target substrate to process the target substrate;
a table including a panel table supporting the target substrate and a fume blocking wall surrounding the panel table;
a cover including an opening overlapping the panel table and fume discharge slits overlapping a space between the panel table and the fume blocking wall; and
a suction cup suctioning fume generated during processing of the target substrate and positioned between the cover and the laser unit, and
wherein the suction cup includes a first suction hole at least partially overlapping an edge of the panel table, and a second suction hole overlapping at least one of the fume discharge slits.

19. The electronic device of claim 18, wherein the table further includes air inlet holes surrounding the edge of the panel table.

20. The electronic device of claim 19, wherein the display panel is cut by the laser processing apparatus.
